(19) United States
(12) Patent Application Publication
(10) Pub. No.: US 2026/0300454 A1
(43) Pub. Date: Oct. 1, 2026

(54) LEAST-PRIVILEGE INCREMENTAL INDEXING IN CROSS-PLATFORM CONTENT EMBEDDING SYSTEMS

(71) Applicant: Atlassian Pty Ltd., Sydney (AU)

(72) Inventors: Abhay Jain, Redmond, CA (US); Yingkai Hu, San Mateo, CA (US); Rahul Revo, Mountain View, CA (US); Jason Xu, Brooklyn, NV (US); Tianchi Ma, Closter, NJ (US); Pavel Aksenkin, Burwood (AU)

(21) Appl. No.: 19/096,414

(22) Filed: Mar. 31, 2025

(51) Int. Cl. G06F 21/31

(52) U.S. Cl. CPC G06F 21/31

(57) ABSTRACT

Collaboration systems configured to incrementally index content stored across multiple software platforms using least-privilege permissions. More specifically, embodiments described herein leverage user-authorized cross-platform embedding to enable incremental indexing of metadata and partial content from remote platforms into local platform datastores without requiring administrator-level integration. More specifically, when a user authenticated at both a local and remote platform embeds remote content into local platform pages, the local platform captures and indexes surface-level metadata, content snippets, and/or access statistics from the remote platform. Incrementally, as more authenticated users view embedded content, the local platform progressively builds an indexed dataset, facilitating multi-platform search functionality and improved generative artificial intelligence context while preserving platform-specific access controls.

### TECHNICAL FIELD

Embodiments described herein relate to data management for multi-user web services and in particular to systems and methods for indexing content and metadata across multiple collaboration platforms configured for cross-platform content embedding.

### BACKGROUND

Organizations retain large volumes of digital content created, managed, or modified by employees. In many cases, organizations license access to one or more collaboration systems which may include third-party systems—for employees to generate, view, share, and/or modify digital content.

However, as an organization grows, content volume likewise grows and nurtures demand for robust custom global search functionality that would equip authenticated users with on-demand access to content, regardless of which collaboration system might store that content. Conventionally, respecting permissions while executing global search operations against content stored in different databases of separate collaboration systems is computationally expensive and slow, especially for organizations that leverage two or more web-based collaboration systems with off-site data storage.

### SUMMARY

Some embodiments described herein take the form of a system for incremental indexing of cross-platform embedded content in a collaboration system with a processing resource and a memory resource cooperating to instantiate an instance of software configured to: receive metadata from a second collaboration platform at a first collaboration platform after a client device, operated by a user and associated with the first collaboration platform, renders first content of the first collaboration platform that embeds second content of the second collaboration platform; storing in a database, by the first collaboration platform, information indicating the user may be authenticated by the second collaboration platform to access the second content; storing in the database, by the first collaboration platform, the metadata and at least a portion of the content; and indexing, by the first collaboration platform, the metadata and the at least a portion of the content such that in response to a search request from the user received at the first collaboration platform, the first collaboration platform generates a result set inclusive of the embedded content.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified system for indexing, by a collaboration system, content and metadata hosted by an external platform.

FIG. 2 depicts a graphical user interface associated with a collaboration system configured for least-privilege incremental indexing of user-embedded external platform content.

FIG. 3 depicts the graphical user interface of FIG. 2, requesting user-level permissions to access external platform content.

FIG. 4 depicts the graphical user interface of FIG. 3, rendering a condensed view of an external platform content item.

FIG. 5 depicts a graphical user interface associated with a global search feature of a collaboration system configured for least-privilege incremental indexing of user-embedded external platform content.

FIG. 6 illustrates a flowchart depicting operations of a method of operating an incremental indexing system as described herein.

FIG. 7 illustrates a flowchart depicting operations of a method of operating an incremental indexing system as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to collaboration systems including multiple purpose-configured software platforms configured for cross-platform content embedding. Specifically, embodiments described herein relate to systems and methods for incrementally indexing, with least-privilege permissions, content hosted by a first platform such that content and metadata can be leveraged by a second platform to, without limitation: provide enriched context to one or more generative output engines; interleave multi-platform content into global search results; generate one or more multi-platform content recommendations; and so on.

It may be appreciated that, as noted above, modern organizations maintain substantial amounts of digital content for various purposes. As employees generate or modify content (collectively, “user-generated content”), an organization may rely on one or more collaboration systems—often licensed from third-party software providers—to support content creation, sharing, and review.

However, as the organization grows, the collective volume of digital content also increases, intensifying demand for robust internal global search capabilities that grant authenticated users rapid access to relevant information. In response, many organizations implement an internal global search service configured with administrative access to each collaboration platform. These architectures effectively integrate the data of multiple collaboration tools together such that user-generated content can be surfaced by the global search service and presented in a single interface, regardless which software platform actually stores and manages that content.

However, system administrators appreciate that deeply integrating multiple platforms together to effectively share all data (either one-way or bidirectionally) is associated with data privacy and/or unintended disclosure risk. More specifically, once an organization integrates two or more platforms together, a vulnerability of any platform may be exploited to obtain data from other platforms. Furthermore, different software platforms often implement separate authentication systems and/or user permissions, role permissions, or other access permissions. As a result, conventional techniques for preserving multi-platform user-specific access controls while executing such global searches across multiple distinct collaboration systems are both computationally expensive and time-consuming.

Due to these and other risks and challenges associated with providing administrator-level integration across conventional multi-platform systems, many system administrators and organizations opt against administrator-level integration, leaving users without any global search functionality and without multi-platform generative artificial intelligence context.

Addressing such challenges and risks, embodiments described herein relate to systems and methods for centrally and incrementally indexing content owned by an organization, regardless whether that content is stored on internal or external platforms, first or third-party platforms, or the like. Further, embodiments described herein accommodate indexing of content across multiple platforms via a least-privilege model, significantly reducing risks associated with administration-level system integration.

More specifically, embodiments described herein leverage user-controlled and user-authorized cross-platform content embedding at a first platform to incrementally index content hosted by a second platform; user-generated content stored and managed by the second platform may be embedded by a user, with permissioned access to both the first and second platform, into content of the first platform. In this manner, when content of the first platform that embeds content of the second platform is rendered, both platforms may perform user authentication. Once the user is authenticated to each platform, the first platform can obtain limited metadata, usage or access statistics, and/or content portions of the content of the second platform. These metadata and content can be stored by the first platform for, among other purposes, indexing of the second platform's content. In this manner, a user of the first platform that performs a search operation in the first platform can be presented with results that include content of the second platform.

As a result of the embedding, and as a result of user-specific permissions enforced by the remote platform, the local platform can obtain at least surface-level metadata and/or partial content in respect of the embedded remote content (e.g., title, body content, icons, addresses, identifiers, and the like). More specifically, any remote platform content that a particular user is authenticated to access via embedding can be captured and stored by the local platform and a permissions note can be recorded alongside information acknowledging that the particular user had been authorized by the remote platform to view the captured and stored data. These content segments (or full content items) and metadata can be stored or indexed by the local platform, and added to a search index, a training dataset, or to other general purpose data stores, data lakes, knowledge graphs, or the like.

It may be appreciated that in view of the foregoing, as more users access content and metadata of the remote platform via piecemeal embeddings into the local platform, the local platform can incrementally assemble a dataset descriptive of content stored by the remote platform, allowing content of the remote platform to, as one example, be included in search results provided to a user when the user performs a global search within the local platform.

As a result of these described constructions, an organization storing a portion of its user generated content in a first platform can at least partially index that content from another, separate, platform. In this manner, the second platform can effectively and expeditiously perform multi-platform search.

For example, an organization may license for its employees a documentation platform and a file storage platform. The two platforms may be developed by separate companies, and may not share permissions structures, databases, or the like. Therefore, to minimize context switching for employees, the organization may permit and/or enable embedding or crosslinking of files stored in the file storage platform into a documents stored by the documentation platform. In this way, a user of the documentation platform can conveniently view documents or files relevant to a particular documentation system page from the page itself, without switching to the file storage platform.

It may be appreciated that as a result of the conveniences provided by cross-platform embedding functionality, users may tend over time to prefer interacting only with the documentation platform. In this manner, when a user executes a search via a search feature of the documentation platform, the user expects that all content previously viewed—including embedded file metadata (e.g., titles, previews, and the like)—will be shown in search results. As a result of the embodiments described herein, such results can be provided while also respecting current user permissions of each platform.

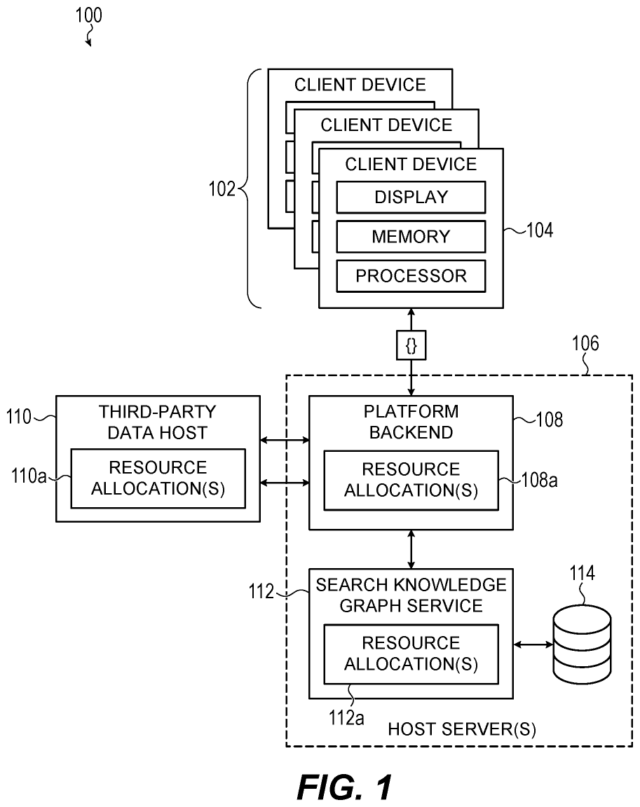

These foregoing and other embodiments are discussed below with reference to FIGS. 1-7. The following examples are provided with respect to these figures for purposes of illustration and example and should not be construed as limiting the disclosure to the explicit examples depicted.

FIG. 1 depicts a simplified diagram of a collaboration system, as described herein, that includes a first platform and a second platform. The system is depicted as implemented in a client-server architecture, but it may be appreciated that this is merely one example and that other communications architectures are possible.

In accordance with the examples provided herein, the system of FIG. 1 can be used to provide a series of interfaces to a document management system, page management system, collaboration system, video sharing system, short message communication systems, or other digital content management or multi-user collaboration system via a computer network. Collectively, such systems can be referred to herein as “software platforms.”

In this manner, a collection of software platforms can define a single collaboration system leveraged by employees of an organization to advance projects and complete work. Some platforms may be tightly integrated, and may be configured to share data via administrator-level integrations. In other cases, however, different platforms may not be integrated either by design or preference, and may maintain separate datastores, permissions structures, and may in some cases be hosted over different physical infrastructure in potentially geographically distinct locations.

As noted above, different platforms may often manage user-generated content and/or user permissions independent of other platforms of a given collaboration system. For example, a documentation platform and a file management platform may independently manage user permissions, content, and metadata.

Also as noted above, some collaboration platforms can be configured for embedding of content of other platforms to reduce context switching burdens. For example, a documentation platform can be configured to allow embedding or cross-linking of files stored by the file management platform. In these examples, the documentation platform can be configured to render a preview, a summary, or other representation of a particular file hosted by the file management platform.

For example, a documentation platform may be used by a human resources (“HR”) department to provide textual descriptions and summaries of company policies. On these pages, the HR department may provide a convenient link to official policy documentation stored by the file management system so that a reader of the HR page can quickly view, in the context of summaries, the official policy document stored by the file management system.

Content can be embedded across platforms in a variety of ways. For example, in some embodiments, a documentation platform can be configured to render a hyperlink (which may be inserted by a user on editing the page) anchored to the file management system as a stylized interface element, with title and description information retrieved from the file management system. In other cases, an iframe rendered in a page of the documentation platform can be used to render a file hosted by the file management system. In other cases, a stylized user interface element with a thumbnail-sized image preview of the document may be provided.

More broadly, it may be appreciated that embodiments described herein relate to configurations in which a collaboration system of an organization includes at least two platforms, one of which is configured to embed content of the other platform. Further, these embodiments relate to systems and methods configured for incremental indexing of content hosted across separate platforms, leveraging a least-privilege access control model.

In particular, as noted above, systems described herein can be configured to specifically leverage user-authorized content embedding between platforms to facilitate the capture and indexing of metadata and partial content from a remote platform (e.g., file management platform) by a local platform (e.g., a documentation platform), without administrator-level integration.

More specifically, a user with authenticated access to both a local platform and a remote platform can embed content hosted by the remote platform into content pages managed by the local platform. Upon rendering of embedded content, both platforms may independently authenticate the user, after which the local platform may retrieve and locally store surface-level metadata, partial content, or access statistics relating to the embedded content. The local platform can index the captured metadata and content segments alongside permission-related information that records prior successful authentication of a user at the remote platform.

Incrementally, as additional users authenticate and view remote content embedded within the local platform, the local platform accumulates an increasingly comprehensive dataset representative of the remote platform's content.

This dataset—and/or other datasets constructed or supplemented via methods and systems described herein—can be leveraged to enhance search functionality, enabling global searches performed at the local platform to return results that directly reference embedded content items of the remote platform.

FIG. 1 illustrates a simplified diagram of a collaboration system 100, configured for incremental indexing of cross-platform content as described herein. The collaboration system 100 includes one or more client devices 102, including a client device 104, communicably coupled via a network to one or more host servers 106.

The client device 104 of the set of client devices 102 may include physical hardware components such as a display, memory, and a processor, which collectively cooperate to execute computer-readable instructions and render graphical user interfaces provided, defined, hosted, or otherwise influenced by the host servers 106. Specifically, the client device 104 can include a processor configured to access a memory to retrieve instructions from that memory. Once the instructions are retrieved, the processor and the memory can cooperate to instantiate an instance of software, such as a browser application, that can be used to access one or more web services of the host servers 106.

The host servers 106 can implement a first platform backend 108 of a first collaboration platform. The first platform backend 108 includes resource allocation(s) 108a which may represent computing resources, including memory, processing, networking, or storage allocations leveraged to execute instances of software configured for content embedding, indexing, or both.

Further, the host servers 106 are communicably coupled, via a suitable network, to a third-party data host 110 which implements a second platform backend with separate resource allocation(s) 110a. The third-party data host 110 may manage content, metadata, and permissions independently of the host servers 106. The third-party data host 110 is configured to serve data and metadata responsive to requests from the first platform backend 108, such as when embedded content hosted by the third-party data host 110 is requested by the first platform backend 108 for rendering in a graphical user interface executed at the client device 104.

In this manner, when embedded content from the third-party data host 110 is requested via an embed or cross-link into the first platform backend 108, the first platform backend 108 may receive metadata from the third-party data host 110 and transmit at least a portion of that content and/or metadata to a search knowledge graph service 112 (which may also include resource allocation(s) configured to index metadata or content captured from a remote platform, such as the third-party data host 110) for indexing in the datastore 114.

Incrementally, as embedded content is viewed or accessed by users of the client devices 102, an index or knowledge graph descriptive of content hosted by the third-party data host 110 can be assembled within the datastore 114, providing subsequent global search functionality across both platforms, contingent on least-privilege authentication enforced by each platform at the time of user requests.

The first platform backend 108 can be configured to infer that a user of the client device 104 is authorized by the third-party data host 110 to view certain content in response to the third-party data host 110 providing a valid response (e.g., not providing a server error, such as a 404, 403, or the like) to a request made by the client device 104 of the first platform backend 108 for content of the first platform backend 108 that embeds content of the third-party data host 110. In this manner, the search knowledge graph service 112 can be populated, in part, with inferred permission information of the third-party data host 110. As a result of this data, the search knowledge graph service 112, in response to a search request from the client device 104, can affirmatively include only those results of the third-party data host 110 that the user of the client device 104 has previously been authorized to view, retrieve, edit, or the like.

In certain embodiments, the first platform backend 108 and/or the search knowledge graph service 112 can be configured to request confirmation from the third-party data host 110 that the user still has permission to access the requested content. This may not be required of all embodiments.

In view of the foregoing, it may be appreciated that generally and broadly embodiments described herein leverage cross-linking features and user-controlled embeddings of content across platforms to incrementally build data sets that allow for indexing of content between a first platform and a second platform, between a local platform and a remote platform, between a first-party platform and a third-party platform and so on, thereby serving as a user-permissions-level data aggregation channel for supporting features such as universal (e.g., multiplatform) search, universal context aggregation (e.g., for retrieval augmented generation or general purpose generative artificial intelligence operations), or for other purposes.

For example, in an embodiment, a first collaboration platform backend may be associated with a short message communication system, while a second collaboration platform backend may host video-sharing content. A user of the short message communication system may embed a link referencing a video stored by the video-sharing platform into a communication thread. On rendering the embedded link as a preview item, a thumbnail or another specially rendered preview user interface element, the short message communication system may authenticate the user to confirm user identity and authorization at both the short message communication system and the remote video-sharing platform.

Once authenticated, the short message communication system may be able to retrieve limited metadata such as a title, a user account associated to uploaded the video, duration, or thumbnail preview from the remote platform and index the same and/or add the retrieved data to a knowledge graph associated with the short message communication systems. Consequently, users of the short message communication system executing searches can be provided, after confirming authentication with the video platform, with search results directly referencing videos of the remote platform based on previously indexed content, data, and metadata.

In another embodiment, a local platform may be configured as an issue tracking system and a remote platform may be a documentation platform. Users authorized on both systems may embed links to specific documentation pages into issue tracking tickets or issue descriptions. When embedded documentation content is requested through the issue tracking system, user authentication at the documentation platform occurs, followed by retrieval and indexing by the issue tracking system of metadata such as document titles, content previews, document identifiers, timestamps, users, teams, editors, commentors, or the like. As with other embodiments described herein, this incremental indexing can progressively populate a knowledge graph or datastore within the issue tracking system, enhancing future searches performed locally with content results referencing embedded documentation pages from the remote platform.

In other cases, a documentation platform can embed content from an issue tracking system. In these cases, metadata and/or content retrieved by the documentation platform from the issue tracking platform can include project status, project identifiers, project titles, work assignees, task completion values, or the like, all of which may indexable as described herein by the documentation platform.

In another example, a local platform can include a collaborative whiteboarding system and a remote platform may be implemented as a third-party image-sharing service. A user with authenticated access to both systems may embed or cross-link images from the third-party image-sharing service within boards of the whiteboarding system. As with other embodiments described herein, on rendering an embedded image, both platforms independently authenticate the user, after which the collaborative whiteboarding system obtains and locally stores metadata about the image, including image identifiers, tags, dimensions, metadata, captions, or descriptions. As further images are embedded across multiple pages by various authenticated users, the collaborative whiteboarding system can incrementally build a local dataset, facilitating the inclusion of image-sharing service results within search queries executed within the whiteboarding application environment.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

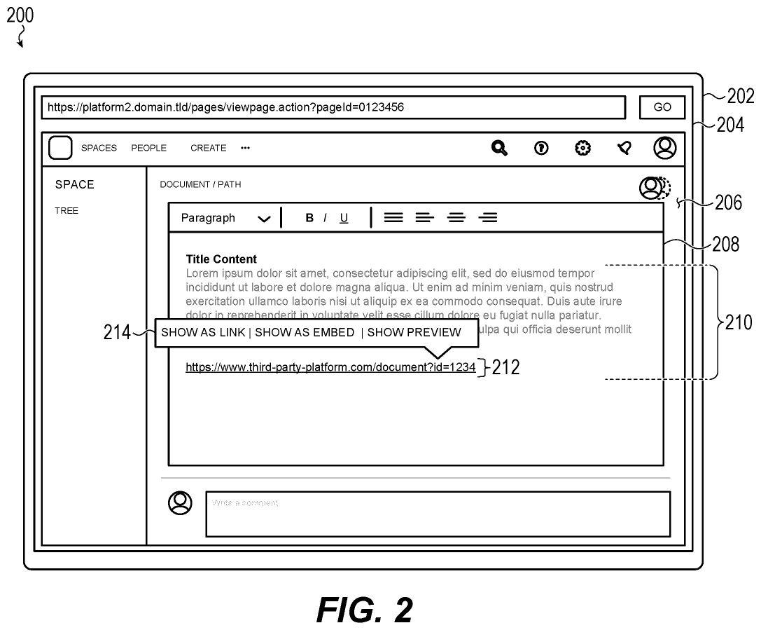

FIG. 2 depicts an example graphical user interface associated with a collaboration system configured for incremental indexing of cross-platform content according to embodiments described herein. The graphical user interface may be rendered within a client application executing on a client device, such as a web browser or another suitable application configured for accessing network-hosted content. More specifically, FIG. 2 depicts a client device 200 that includes a housing 202 that encloses and supports a display 204. The display 204 can be operated by a processor or memory of the client device 200 to render a graphical user interface 206.

The graphical user interface 206 can be configured in a number of suitable ways and may include a number of different graphical user interface elements, affordances, and content regions. For example, in some embodiments, the graphical user interface 206 can include an address bar that can correspond to a unique address of particular content stored by the collaboration system. The graphical user interface 206 can also include an editing region 208, which may be a rich-text or other interactive editing area, and may be provided for receiving and rendering user-generated content, such as the text content 210.

In the illustrated example, the user-generated content 210 includes a textual description and a hyperlink 212 (inserted via paste event by a user, as an example) referencing external content stored on a third-party or remote platform. In this manner, when a user interacts with the hyperlink 212, a selectable embedding option interface 214 can be displayed.

The embedding option interface 214 allows the user to select a preferred embedding style for the external content when the external content is rendered alongside the user-generated content 210. In the embodiment shown, embedding options include, without limitation, displaying the referenced content as a simple hyperlink (“SHOW AS LINK”), embedding the external content directly within the current content editing region (“SHOW AS EMBED”), or rendering a condensed or representative preview of the external content (“SHOW PREVIEW”). Other embedding options and interface elements may also be provided in alternative embodiments.

As with other embodiments described herein, upon selection of an embedding option or style, the collaboration system and/or the remote system can authenticate the user with respect to both the local collaboration platform and the remote platform hosting the external content described by the hyperlink 212.

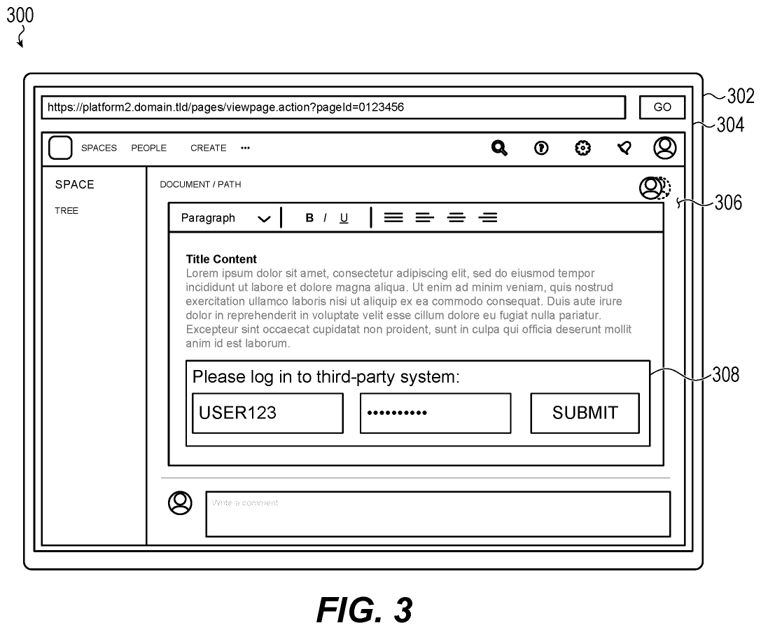

For example, FIG. 3 depicts the graphical user interface of FIG. 2, requesting user-level permissions to access external platform content. As with FIG. 2, FIG. 3 depicts a client device 300 that includes a housing 302, a display 304, and a graphical user interface 306. In this example, the graphical user interface 306 can be configured to render—by operation of the remote system—an embedded authentication interface 308, which may be automatically displayed in response to user interaction with embedded or cross-linked external content hosted on the remote, third-party platform indicated by the external content indicated by the hyperlink 212.

In this embodiment, the authentication interface 308 prompts the user to provide credentials (e.g., username, password, tokens, or other authentication data) required by the remote platform to confirm user authorization and permit access to the requested embedded content. After receiving valid credentials via the authentication interface 308, the remote platform authenticates the user and thereafter allows the local collaboration system to retrieve and locally index metadata, partial content, and other relevant data related to the requested content as described above.

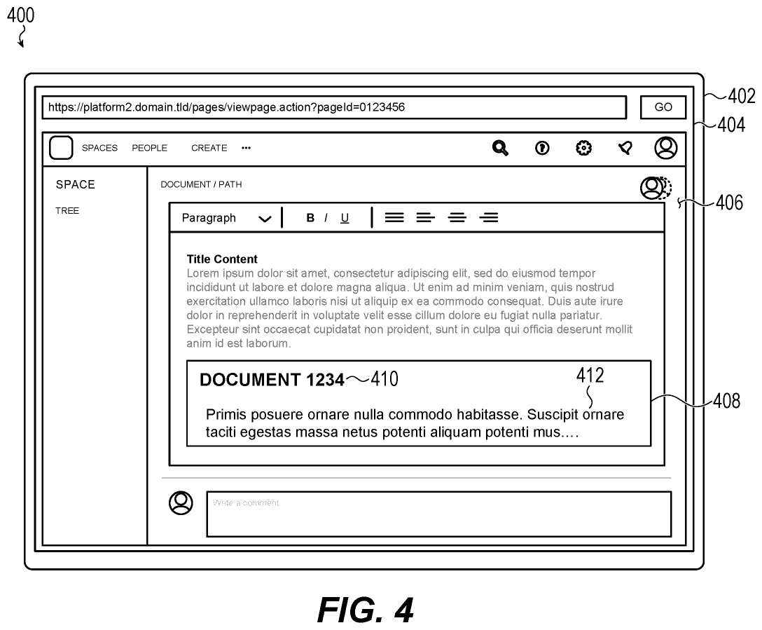

FIG. 4 depicts the graphical user interface of FIG. 3, rendering a condensed view of an external platform content item. As with the embodiments depicted in FIGS. 2-3, the client device 400 depicted in FIG. 4 includes a housing 402 that encloses and supports a display 404 that can be used to render a graphical user interface 406.

The graphical user interface 406 depicts what may follow successful authentication by the user to the third-party platform as shown in FIG. 3. As described in respect of other embodiments referenced herein, after authentication, the external content previously referenced by hyperlink (212 in FIG. 2) is now rendered as embedded content 408 directly within the editing area of the local collaboration system.

More specifically, the embedded content 408 can take a number of forms. For example, FIG. 4 depicts the embedded content 408 as a condensed or preview format, facilitating user comprehension and reducing the need to navigate away from the current context. Specifically, the embedded content 408 may include metadata such as a content title 410 or identifier (“DOCUMENT 1234”), as well as a partial content preview or a snippet 412. This partial preview 412 may include an excerpt, abstract, or summary of the full document or other content item hosted by the remote third-party platform, facilitating incremental indexing by local collaboration system.

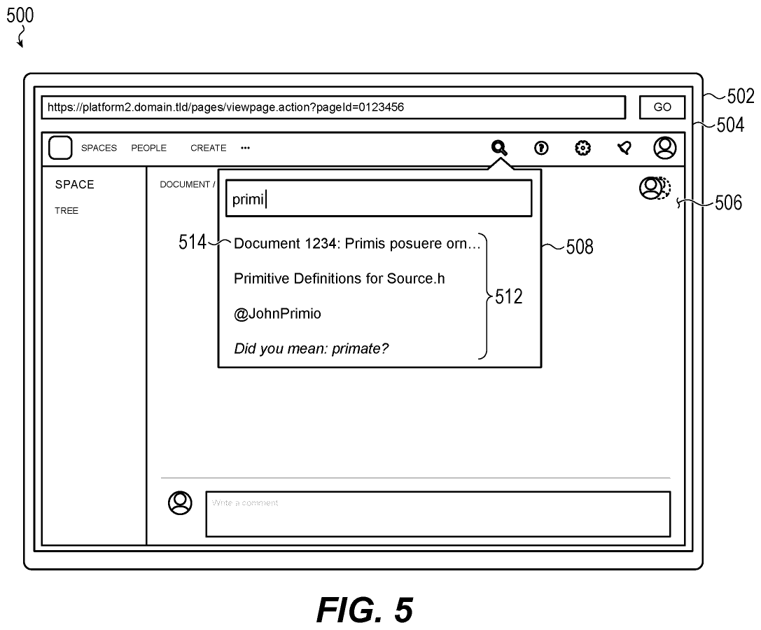

FIG. 5 depicts a graphical user interface associated with a global search feature of a collaboration system configured for least-privilege incremental indexing of user-embedded external platform content. In particular, FIG. 5 depicts a client device 500 that includes a housing 502 supporting a display 504 that in turn can be leveraged to render a graphical user interface 506. In this example, the collaboration system includes a search interface 508 that is depicted in an active state, displaying real-time search suggestions or results as the user enters a query (in the illustrated example, a partial input: “primi”). The search interface 508 includes a list of search results 512, dynamically generated based content and/or metadata indexed by the local collaboration system, which can include items from both the local platform and remotely hosted content previously embedded and indexed incrementally through user interactions described herein.

More specifically, the search results 512 include a result 514 referencing the previously embedded content (“Document 1234”, see e.g., FIG. 4) from the third-party platform described in reference to FIGS. 2-4 . As a result of the incremental indexing (by users accessing content of the collaboration system of FIG. 5) previously performed, the local platform can present search results directly referencing remote content, without requiring administrative-level integration, while still respecting least-privilege permissions (e.g., only users that are authorized to access local content and authorized—by a remote system—to access remote content will be able to view cross-platform embedded content and search for cross-platform embedded content).

It may be appreciated that results shown to a particular user are based on that particular user's permission, combined, in respect of both a first platform and a second platform. A user with permissions to view a document of a first platform may not necessarily have permission to view an embedded video of a second platform within that document. In this example, a user searches the first platform, the document may be returned as a result but the video will be withheld, as the user does not have appropriate permissions to view it. Conversely, if the user is permitted to view the video but not permitted to access the document, a search performed by the user on the first platform may not return any results, as the first platform has not been able to index any permissions information or inferences on behalf of the user through the document. In other cases, a system as described herein can be configured to perform last-mile permissions checks for every third-party data content item; in these examples, a user permitted to view an off-site content item (such as the video) may have the video included in search results despite that there are no documents that embed the video that the user has authorization or permission to view.

These foregoing embodiments depicted in FIG. 2-5 and the various alternatives thereof and variations thereto are presented, generally, for purposes of explanation, and to facilitate an understanding of various configurations of a user interface, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

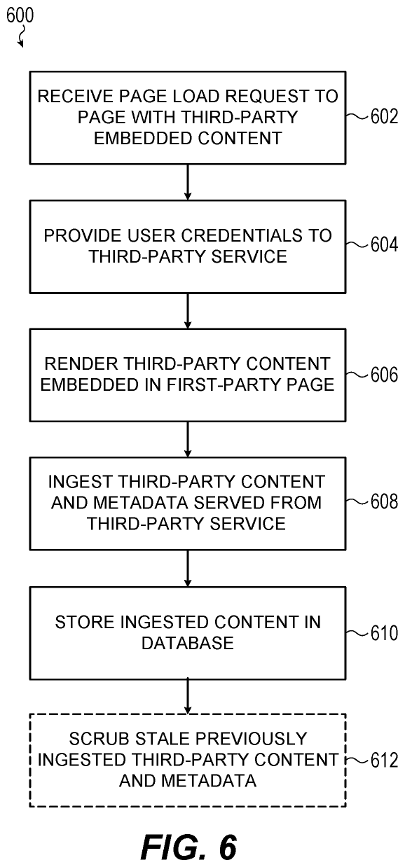

FIG. 6 illustrates a flowchart depicting operations of a method of operating an incremental indexing system as described herein. The method 600 includes operations for incremental indexing of third-party content within a collaboration system according to embodiments described herein.

The method includes operation 602, in which a page load request is received at a local (first-party) platform, such as a documentation platform. In embodiments, the requested page includes embedded content hosted by a third-party (remote) platform. At operation 604, user credentials can be provided by the local platform to the third-party service for authentication by that platform. As with other embodiments described herein, authentication may involve passing tokens, credentials, or other authentication data to ensure the requesting user has appropriate access rights. Once authenticated the method can advance to operation 606, at which embedded third-party content is rendered within the first-party page, such as described above. As with other embodiments described herein, rendering may include operations such as displaying condensed previews, embedded views, or stylized hyperlinks, or the like.

The method 600 includes operation 608, at which the local platform ingests metadata and/or partial content associated with the authenticated, embedded, third-party content and metadata (including metadata describing user interactions with the embedded content, such as cursor movements, hover durations, and the like). The metadata, user interactions, and content are retrieved from and/or generated once the third-party service successfully authenticates the user. In addition, as noted above, in some embodiments, ingested data can include an authentication inference in which the local platform infers that the remote platform has authenticated any user able to successfully view the embedded content.

Following ingestion, at operation 610, the local platform stores the ingested metadata and content in a local database or datastore. As noted above, stored information may be added to knowledge graphs, data lakes, or other suitable data storage and indexing structures to facilitate incremental indexing and enhanced global search functionality.

Optionally, at operation 612, the local platform can periodically scrub or remove stale or outdated metadata and content previously ingested from the third-party platform. This ensures the indexed data remains accurate, current, fresh, and compliant with current permissions. In many cases, the expiration interval may vary from embodiment to embodiment, content type to content type, or the like. As one example, content may expire after having not been viewed by any user for a period of four weeks (twenty eight days). In other cases, other durations may be selected.

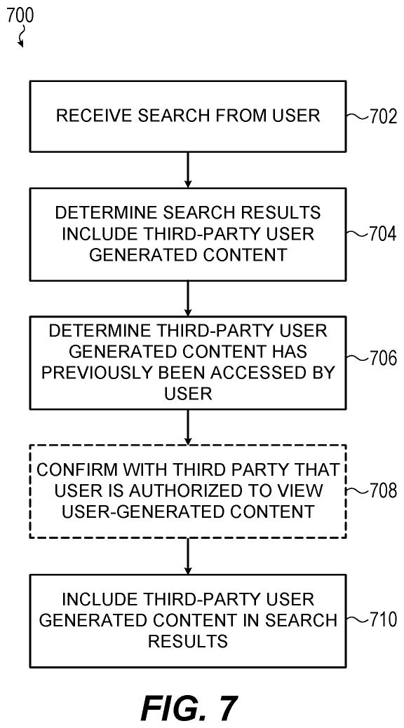

FIG. 7 illustrates a method 700 depicting example operations for performing a global search leveraging incrementally indexed third-party content within a collaboration system, according to embodiments described herein.

At operation 702, the local platform receives a search request from a user. This request can originate from various client interfaces provided by the local collaboration system, such as a search bar or command interface rendered within a graphical user interface.

At operation 704, the local platform determines that relevant search results responsive to the user's search query include user-generated content or metadata indexed from a remote or third-party platform. The determination may be made using metadata or partial content previously indexed incrementally via prior user-authorized content embedding and rendering events, as described above.

At operation 706, the local platform further determines whether the third-party user-generated content identified in operation 704 has been previously accessed by the searching user. The local platform can perform this determination based on stored metadata and previously inferred permissions or authorization information, recorded when the content was previously embedded and accessed by the user.

Optionally, at operation 708, the local platform may further confirm with the third-party platform whether the searching user remains currently authorized to access the third-party user-generated content. Such confirmation ensures that indexed content permissions remain current, consistent, and aligned with the permissions enforced by the third-party platform.

Finally, at operation 710, the local platform includes results referencing the authorized third-party user-generated content in the search results provided to the user. In this manner, the local collaboration system effectively leverages incremental indexing and previously inferred or confirmed permissions to ensure users receive relevant and authorized cross-platform search results.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments described herein are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

What is claimed is:

1. A computer-implemented method of incremental indexing of cross-platform embedded content, the method comprising:
receiving, within a page of a documentation platform, an insertion into an editable text region of a graphical user interface by a user, of a reference to remote content hosted by an external platform;
subsequent to a successful authentication of the user with respect to the remote platform and responsive to detecting the insertion:
receiving metadata from the remote platform describing the remote content; and
rendering within the graphical user interface at least a portion of the remote content or at least a portion of the received metadata in place of the user-inserted reference;
storing, by the documentation platform, the metadata; and
subsequent to storing the metadata, indexing the metadata such that in response to a search request from the user received at the documentation platform, the documentation platform generates a result set inclusive of the external content.

2. The computer-implemented method of claim 1, further comprising storing, by the documentation platform, information indicating the user is authenticated by the external platform to access the remote content.

3. The computer-implemented method of claim 2, prior to receiving metadata from the remote platform, rendering in the graphical user interface an embedded authentication interface associated with the remote platform.

4. The computer-implemented method of claim 1, further comprising storing, by the documentation platform, the remote content.

5. The computer-implemented method of claim 1, wherein the metadata comprises at least one of:
a project identifier of the remote content;
a title of the remote content;
a runtime length of the remote content; or
a content thumbnail.

6. The computer-implemented method of claim 1, comprising prior to generating the result set, confirming by the documentation platform from the external platform that the user is authorized to access the external content.

7. The computer-implemented method of claim 1, comprising rendering within the documentation platform a preview of the remote content based at least in part on the retrieved metadata.

8. The computer-implemented method of claim 1, wherein:
the user is a first user;
the search request is a first search request; and
in response to a second search request from a second user received at the documentation platform, the documentation platform generates a result set inclusive of the external content upon confirmation that the second user is authorized by the remote platform to view the external content.

9. The computer-implemented method of claim 1, comprising in response to each subsequent page load request of the page, retrieving metadata from the remote platform describing the remote content after authentication of the user by the remote platform.

10. The computer-implemented method of claim 1, wherein the reference is a hyperlink.

11. A system for incremental indexing of cross-platform embedded content in a collaboration system comprising a first collaboration platform and a second collaboration platform, the system comprising:
a host server comprising a processing resource and a memory resource cooperating to instantiate an instance of software configured to:
receive a request to render, at a graphical user interface operated by a user of a client device communicably coupled to the first collaboration platform, content of the first collaboration platform, the content comprising embedded content of the second collaboration platform;
after loading of the content in the graphical user interface, receiving metadata from the second platform describing the embedded content;
causing to be rendered at the graphical user interface, a user interface element comprising at least a portion of the received metadata;
storing, by the first collaboration platform, information indicating the user is authenticated by the second collaboration platform to access the embedded content;
storing, by the first collaboration platform, the metadata and at least a portion of the content; and
indexing, by the first collaboration platform, the metadata and the at least a portion of the content such that in response to a search request from the user received at the first collaboration platform, the first collaboration platform generates a result set inclusive of the embedded content.

12. The system of claim 11, wherein the instance of software is configured to request confirmation that the user is authorized to view the embedded content prior to rendering the result set.

13. The system of claim 11, wherein:
the client device is a first client device;
the user is a first user;
the graphical user interface is a first graphical user interface;
the instance of software is further configured to:
receive a request to render, at a second graphical user interface operated by a second user of a second client device communicably coupled to the first collaboration platform, the content; and
storing, by the first collaboration platform, information indicating the second user is authenticated by the second collaboration platform to access the embedded content.

14. The system of claim 11, prior to receiving metadata from the remote platform, rendering in the graphical user interface an embedded authentication interface associated with the remote platform.

15. The system of claim 11, comprising storing, by the documentation platform, the embedded content.

16. The system of claim 11, wherein the metadata comprises at least one of:
a title of the embedded content;
a runtime length of the embedded content; or
a thumbnail.

17. The system of claim 11, wherein the first collaboration platform is configured to store the metadata and the at least a portion of the embedded content in a data store.

18. The system of claim 17, wherein the first collaboration platform is configured to remove the metadata from the data store after a time period.

19. A system for incremental indexing of cross-platform embedded content in a collaboration system comprising a processing resource and a memory resource cooperating to instantiate an instance of software configured to:
receive metadata from a second collaboration platform at a first collaboration platform after a client device, operated by a user and associated with the first collaboration platform, renders first content of the first collaboration platform that embeds second content of the second collaboration platform;
storing in a database, by the first collaboration platform, information indicating the user is authenticated by the second collaboration platform to access the second content;
storing in the database, by the first collaboration platform, the metadata and at least a portion of the content; and
indexing, by the first collaboration platform, the metadata and the at least a portion of the content such that in response to a search request from the user received at the first collaboration platform, the first collaboration platform generates a result set inclusive of the embedded content.

20. The system of claim 19, wherein the instance of software is configured to:
receive second metadata from the second collaboration platform at the first collaboration platform after the client device renders third content of the first collaboration platform that embeds fourth content of the second collaboration platform; and
storing in the database, by the first collaboration platform, information indicating the user is authenticated by the second collaboration platform to access the fourth content.

21. The system of claim 19, wherein the instance of software is configured to receive and index the remote content, prior to storing the metadata.

22. The system of claim 19, wherein the instance of software is configured to return the result set only in response to a confirmation received from the second collaboration platform that a sender of the search request is authorized to access the metadata and the at least a portion of the content.
